(19) United States
(12) Patent Application Publication
(10) Pub. No.: US 2015/0100632 A1
(43) Pub. Date: Apr. 9, 2015

(54) VOICE-DRIVEN SOCIAL MEDIA

(71) Applicant: Suraj Bhagwan Panjabi, Mumbai (IN)

(72) Inventor: Suraj Bhagwan Panjabi, Mumbai (IN)

(21) Appl. No.: 14/047,264

(22) Filed: Oct. 7, 2013

(51) Int. Cl. H04L 29/08; G06F 3/16

(52) U.S. Cl. CPC H04L 67/306; G06F 3/165; G06Q 50/01
USPC 709/204

(57) ABSTRACT

A method for facilitating social media interactions is disclosed. The method comprises: allowing a user to record an audio clip as a primary step; and allowing the user to post said audio clip to a voice portal; and organizing the audio clips posted by the user on a profile page associated with the user on the voice portal so that each audio clip forms a center for social interaction subsequent social media interactions.

### FIELD

Embodiments of the present invention relate to social media.

### BACKGROUND

Social media includes the means whereby people create, share, and/or exchange information and ideas in virtual communities and networks. Social media depends on mobile and web-based technologies to create highly interactive platforms through which individuals and communities share, co-create, discuss, and modify user-generated content.

### SUMMARY

According to one aspect of the invention, there is provided a method for facilitating social media interactions. The method comprises allowing a user to record an audio clip as a primary step; and allowing the user to post said audio clip to a voice portal; and organizing the audio clips posted by the user on a profile page associated with the user on the voice portal so that each audio clip forms a center for social interaction subsequent social media interactions.

The subsequent social media interactions may at least be by friends of the user.

The subsequent social media interactions may be selected from the group consisting of a comment about an audio clip, a posting of the audio clip to a social media site; and an indication of a liking or a disliking of an audio clip.

The comment may be captured through one of text and voice.

The method may further comprise allowing the user to perform a secondary step in connection with the audio clip.

The secondary step may comprise tagging the audio clip.

The secondary step may comprise associating an image with audio clip.

The image may represent a photograph, or greeting.

The method secondary step may comprise associating background audio with the audio clip.

Other aspects of the invention will be apparent from the detailed description below.

### BRIEF DESCRIPTION OF THE FIGURES

FIG. 1 shows a deployment scenario, in accordance with one embodiment of the invention.

FIG. 2 shows a user interface for a console, in accordance with one embodiment of the invention.

FIG. 3-5 shows aspects of a user interface for a voice portal, in accordance with one embodiment of the invention.

FIG. 6 shows a flowchart of a method for facilitating social interactions, in accordance with one embodiment of the invention

FIG. 7 shows an example of hardware for a voice portal, in accordance with one embodiment of the invention

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose social media in which the social experience is driven by voice.

In one embodiment the social media includes a web portal and an application whereby connections may be made to the web portal by users (hereinafter also referred to as “friends” or by variants of “friends”).

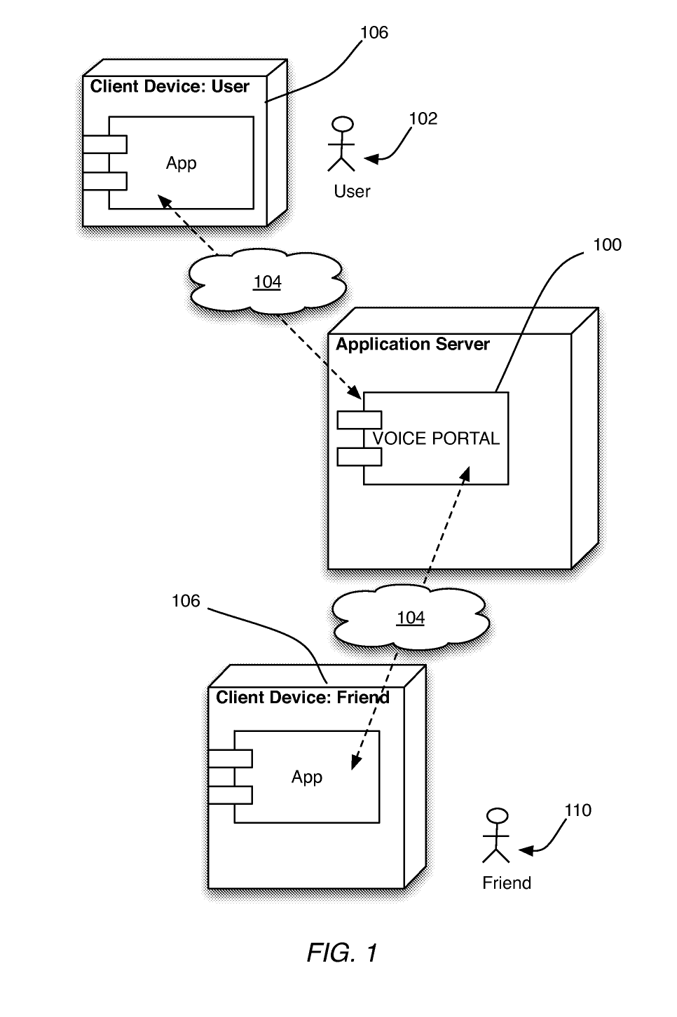

FIG. 1 shows a deployment scenario for the inventive social media, in accordance with one embodiment. Referring to FIG. 1, a voice portal 100 runs on an application server. The portal 100 may comprise a cloud-based system that supports connections with users via an intermediate network 104. Said connections may be made using any commonly used client devices 106 such as a notebook computer, smartphone, etc. The network 104 may support any networking protocol and in one embodiment may comprise the Internet. The user devices 106 run an application 108 (typically a mobile application) that communicates with the voice portal 100 to facilitate voice-driven social media interactions between friends. For ease of reference, a user who posts/publishes media to the voice portal 100 will be referred to as user 102, whereas a friend who uses or consumes a post will be referred to as a friend 110.

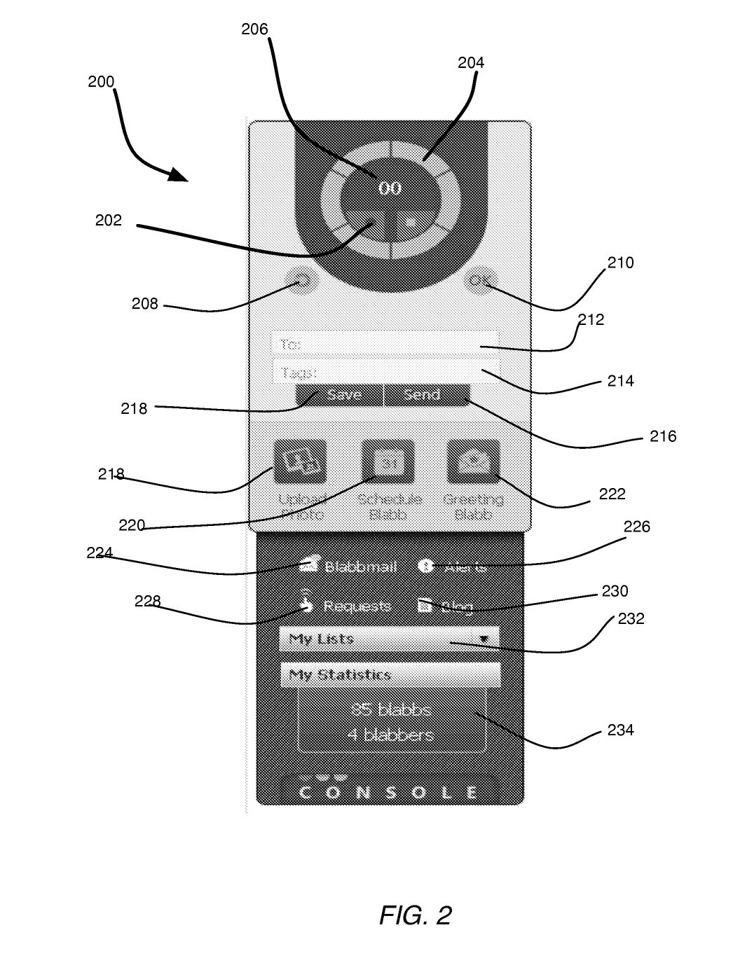

In one embodiment, the portal 100 may include a console to facilitate a social experience that is driven by voice. The console may allow a user to record a voice clip for sharing with other friends. FIG. 2 shows a user interface 200 corresponding to the console, in accordance with one embodiment.

In one embodiment, the console may be configured to support the followings features, functions, and interactions (“you” in the following description is a reference to the user 102):

(a) Socializing with People Online—

Recording a voice clip (also referred to herein as a “blabb”) to share with your friends on the voice portal 100.

Step 1: The total time given to record a blabb may be limited to 30 seconds. Button 202 on the console indicates a record button. In one embodiment, once the button 202 is selected, a dial countdown to 30 seconds starts. The dial countdown is indicated graphically by dial 204. A numerical readout 206 indicates a length of a current recording in seconds. A play button may enable the user 102 to listen to what the user has just recorded. If the user 102 does not like was recorded or want to re-record the blabb, the user 102 may select button 208 to record a new blabb. Button 210 may be uses to confirm that the user 102 is satisfied with a blabb.

Step 2: Once the user 102 has recorded the blabb, box 212 may used to capture a ‘To’ field. This is the field that is used to input, e.g. type in, an individual's name or list name to send it to specific users/friends or send it to yourself as a status update known as ‘Hear me out’. For example, typing John in the box 212, causes the console to pull up names of all people with a first name or last name of “John”, or lists in which John is added. In one embodiment, if the user 102 selects himself/herself or leaves the To field blank, then the blabb is posted as a Hear me out.

Step 3: In one embodiment, the user 102 may add a tag (in box 214) so that users can search for a blabb using the tag. For example, if the user 102 records a blabb about patents, then a tag called ‘patent’ may be used to tag the blabb. Thus, anyone searching for a blabb with the ‘patent’ tag, will find all blabbs tagged with the tag “patent” in search results.

Step 4: The user 102 can send the blabb using the button 216. The user 102 can also save the blabb by selecting the button 218. Blabbs may be save in a “Drafts” folder, in one embodiment.

(b) Hear Me Out:

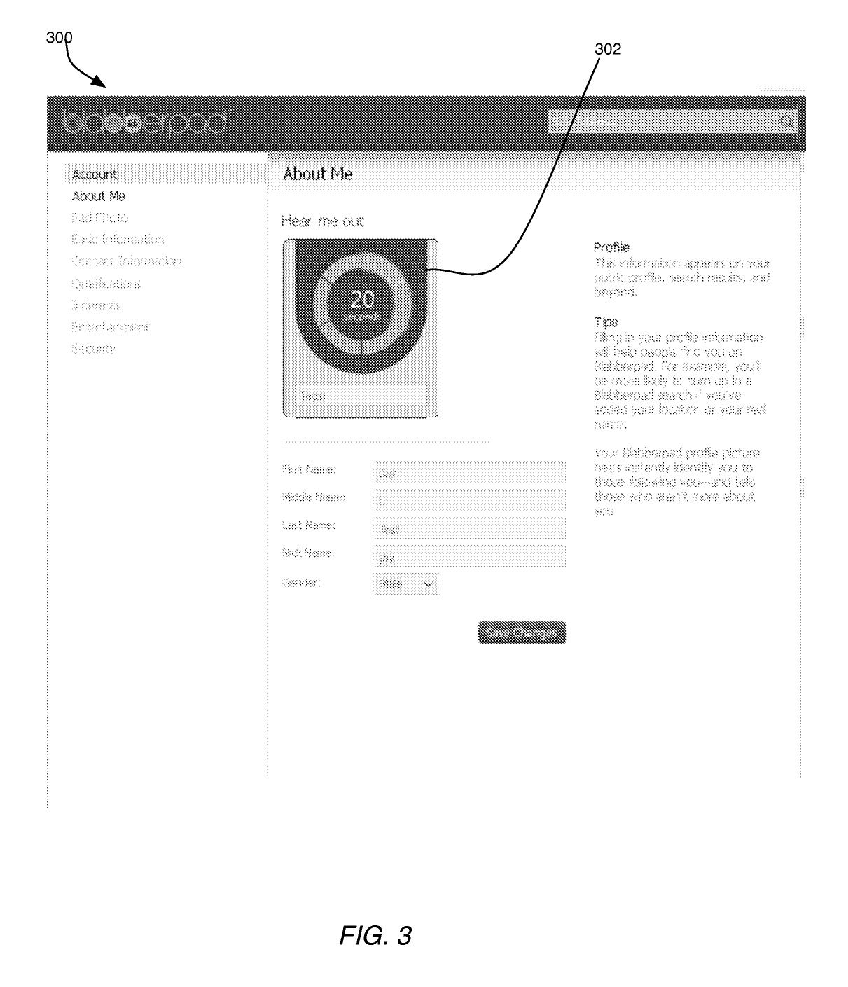

This features the user 102 to record a blabb that is accessible from a user's public profile page on without any information in the “To” field will be used to update the “Hear me out” blabb. FIG. 3 shows a public profile page 300 with the “Hear me out” blabb 302. The “Hear me out” blabb may used to provide information for general consumption and is akin to a status update used in social media such as Twitter and Facebook.

(c) Record a Blabb and Upload a Photo:

In one embodiment, a blabb may be recorded as described above. However, the user 102 may be allowed to select a photo or create a new one, add a caption to the photo, and the post the blabb/photo combination. Button 218 on the console allows the user 102 to upload a photo as described.

(d) Schedule a Blabb:

In one embodiment, a blabb can be sent now or at a later time. Button 220 on the console allows the user 102 to schedule a blabb to be sent at a later time.

(e) Greetings:

In one embodiment a gallery of greeting images may be provided. The user 102 may be allowed to select a greeting image from the gallery to be used with a blabb. Said blabb is then recorded as described above. The blabb and greeting image may be previewed prior to being sent or saved in a drafts folder, as described above. Button 222 on the console allows the user 102 to create a greeting blabb as destibed.

(f) Blabbmail:

With this feature the user 102 can record a blabb to be sent to a specific friend 110 his/her blabbmail. In one embodiment, blabbmail serves as an inbox for the user 102 on the voice portal 100. The user 102 can see his/her inbox or sent items and listen to blabs in his/her blabbmail. Button 224 on the console allows the user 102 to access his/her blabbmail.

(g) Alerts:

These are the notifications you receive every time someone sends you a blabb or any activity related to you on Blabberpad. Button 226 on the console allows the user to view alerts.

(h) Requests:

People who want to add you as a friend may send you a friend request. In one embodiment, each friend request may display their ‘hear me out’ tabs. The latter may be played to get sense of the person making the friend request. Button 228 on the console allows the user 102 to view requests.

(i) Blogs:

Here the user 102 can record a blabb which functions as a blog. In embodiment, the user 102 may be allowed to write a description with an unlimited character limit for sharing with specific users or lists. Button 230 on the console allows the user 102 to view blogs associated with the user.

(j) My Lists:

The user 102 may be allowed to create lists. “My Lists” allows the user 102 to see the lists said user has created. A list is where you can manage your blabbers and keep all your friends in the ‘buddies’ list, a few blabbers in an ‘office’ list, etc. Button 218 on the console allows the user 102 to upload a photo as described. Button 232 on the console allows the user 102 to access his/her lists.

(k) My Statistics—

This is a statistics box that keeps updating with the number of blabbs you have recorded till today and the number of blabbers you have on Blabberpad (Blapperpad is the user interface to the voice portal 100). Box 234 on the console allows the user 102 to view the aforementioned statistics.

(l) Blabbers—

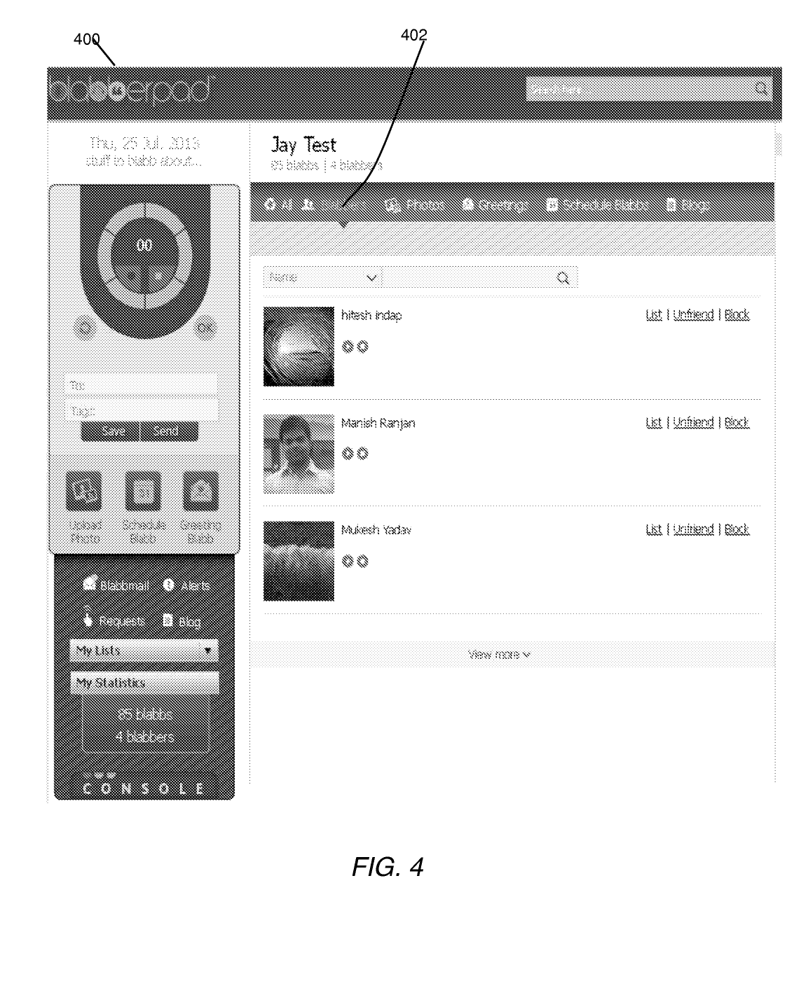

Every one on the voice portal 100 is known as a ‘Blabber’. Selecting the “Blabbers” button 492 on the blabber pad 400 shown in FIG. 4 shows you all the people who you have added and you can listen to, their hear me out blabb, add them to a list, cancel their request to add you, add, or block them.

(m) Photo Views:

In one embodiment, the voice portal 100 may provide two modes for a user to view photo albums. In smart view, the albums are displayed in the first row, the photos of that album in the third and a large view of the selected photo in the third. In classic view, all photo thumbnails and when clicked, a larger view of that photo is shown.

(n) My Pad Photo:

Your profile page is known as My Pad. The profile photo on My pad is known as Pad Photo. The online button below the name appears in green when you have logged in. Blabbers button is the default list every blabber is put into once they create an account.

(o) Actions Bar:

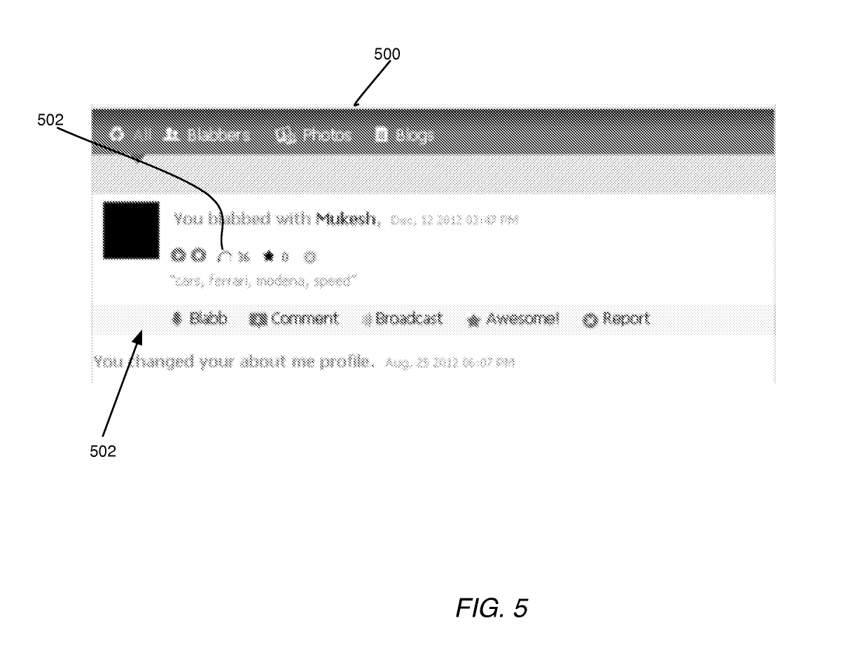

FIG. 5 shows an embodiment 500 of a user interface for the portal 100. As will be seen, the interface 500 includes an actions bar 502 which allows the user 102 to perform the following actions:

Blabb: You can blabb over another blabb

Comment: Write a text comment

Broadcast: Share it with a few blabbers, lists or everyone

Awesome: The star icon is to mark every blabb you like as ‘awesome’

Report: If you do not like a blabb or find it offensive then report it.

(o) Number of Listens.

The headphone icon 502 indicates the number of people that have heard a blabb.

Blabb Login:

In one embodiment, users access the portal 100 using their valid email address and password. The password may be spoken and recognized by the portal 100 through voice recognition.

Blabbs with Customized Background Sound:

The user 102 can select a pre-listed background sound or upload a music clip, which will be played in the background of the Blabb(s) recorded by the user. The user can set this background as a default for every blabb they record or have it on a case-by-case basis.

Links:

You can link one blabb to another. If you record one blabb and have something more to say but there are many more blabbs shown after you recorded your first, you can record another blabb and link it to your first one.

Interactive Voice Response (IVR):

Users have to subscribe to this feature, which allows a user to record a blabb by dialing a phone number and providing a PIN or password. Users can dial a toll free number 1-800-025222 (One-Eight Thousand-BLABB) and put input their PIN to:

Record a blabb after which a sound tells them its over;

For e.g., Dial 1 to listen, 2 to record again, 3 to save it as a draft and 4 to delete the blabb and hang up.

The recorded blabb is then posted on the user's profile on the portal 100.

Debates:

Imagine a person sending a blabb about, e.g. a school shootout incident that sparks outrage on the Internet. A special page for debate with “For” and “Against” sections with blabbs for each stand will be made. Anyone can start a debate and invite other blabbers to the page.

Business Blabbs:

Here companies can create a page for their brand where people do not have to add the brand as per the current privacy settings. This will be treated as an open page where anyone can go to the page and blabb about it. Companies can buy the blabb if they like it to promote their brand that will be displayed on the login page for a short period of time.

Blabb News:

News channels and journalists can broadcast 30-second headlines constantly to send out news to people on the move through blabbs.

Blabbtab:

Track the exchange of blabbs between any two blabbers on your list from the time they added each other

Shout Outs:

Pre-recorded 5-second blabbs like “hey what's up”, “call me back asap”, “I'm busy right now”

Flag:

You can flag a blabb in your Blabbmail inbox or any blabb that you might want to get back to later

Apps:

Voice enabled—Calendar, notes (read out to-do lists to yourself), presentations, Horoscopes. A feature that reads out the content you blabbed or typed. Usage:
A blabb will have a pause, rewind and forward button.
While the blabb is being recorded, the frequency bar would indicate the level of volume.
You can even add sounds beats in the background while you record your blabb Eg: drumroll, piano, instrumental music . . . )
Rate the clip. 1-5 stars, 1=my ears are shut, 2=can't tolerate, 3=I'm listening, 4=Say it again, 5=Sounds good
Promoted blabbs would appear on a welcome page

Random:

This feature starts playing random blabbs one after the other. The blabs are randomly picked from different profiles.

Download:

This feature allowa a user to download and save a blabb.

Customized Privacy Settings:

Blabbers can choose to show their blabbs only to certain people on their list or block people from viewing a part of their activity on Blabberpad.

Attachments:

Users can also upload voice blabbs from their phones & computers. These attachments will be limited to 30 seconds only.

Status:

People can show what music they are listening to from their iTunes/music library on their device

Groups:

You can create groups by adding selected friends to that group and share blabbs with those people like a chat room. Not live chat.

Channels:

In one embodiment, different channels may be setup to allow people talk about different topics. Eacj blabb needs to be tagged in order to appear on a ‘channel’

Suggestion:

Blabbs may be recommended or suggested to other blabbers by forwarding it to them

Sharing:

In one embodiment, links may be attached to blabs to facilitate posting on other social median such as Facebook and Twitter.

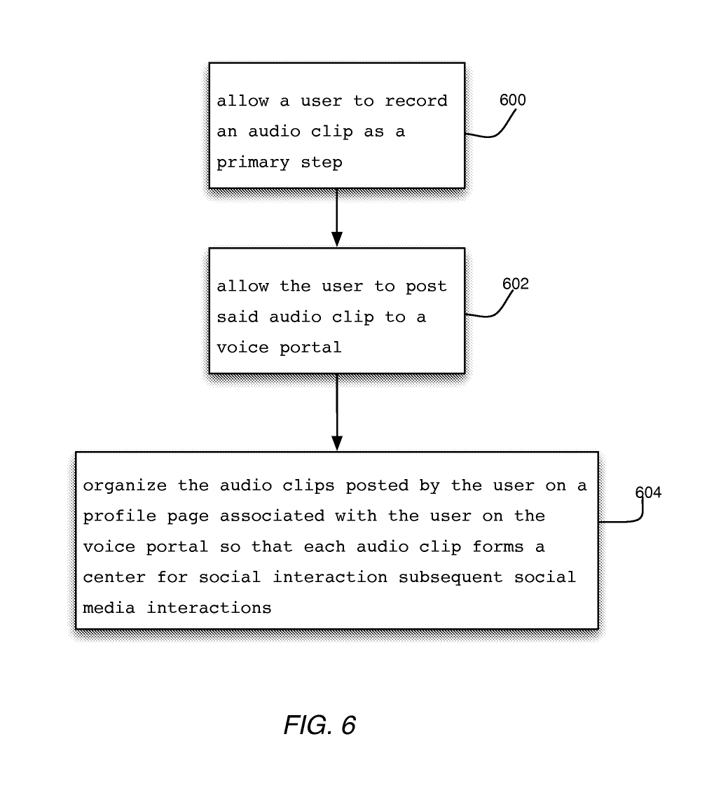

Unlike social media such as Twitter and Facebook, embodiments of the present invention facilitate social media interactions where a voice clip is the primary driver of the social media experience. Embodiments of the invention may be realized as a method for facilitating social media interactions according to the flowchart of FIG. 6. Referring to FIG. 6, the method may include the following processing blocks:

Block 600: allowing a user to record an audio clip as a primary step; and

Block 602: allowing the user to post said audio clip to a voice portal; and

Block 604: organizing the audio clips posted by the user on a profile page associated with the user on the voice portal so that each audio clip forms a center for social interaction subsequent social media interactions.

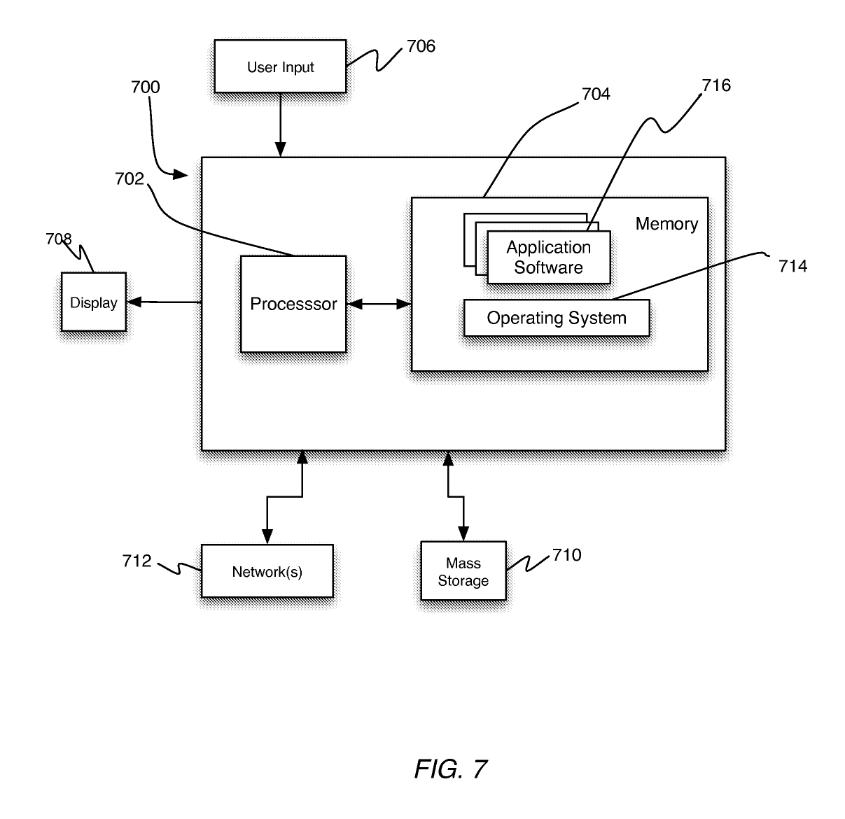

FIG. 7 shows an example of hardware 700 that may be used to implement the portal 100. The hardware 700 typically includes at least one processor 702 coupled to a memory 704. The processor 702 may represent one or more processors (e.g., microprocessors), and the memory 704 may represent random access memory (RAM) devices comprising a main storage of the hardware 700, as well as any supplemental levels of memory e.g., cache memories, non-volatile or back-up memories (e.g. programmable or flash memories), read-only memories, etc. In addition, the memory 704 may be considered to include memory storage physically located elsewhere in the hardware 700, e.g. any cache memory in the processor 702, as well as any storage capacity used as a virtual memory, e.g., as stored on a mass storage device 710.

The hardware 700 also typically receives a number of inputs and outputs for communicating information externally. For interface with a user or operator, the hardware 700 may include one or more user input devices 706 (e.g., a keyboard, a mouse, a scanner etc.) and a display 708 (e.g., a Liquid Crystal Display (LCD) panel). For additional storage, the hardware 700 may also include one or more mass storage devices 710, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 700 may include an interface with one or more networks 712 (e.g., a local area network (LAN), a wide area network (WAN), a wireless network, and/or the Internet among others) to permit the communication of information with other computers coupled to the networks. It should be appreciated that the hardware 700 typically includes suitable analog and/or digital interfaces between the processor 702 and each of the components 704, 706, 708 and 712 as is well known in the art.

The hardware 700 operates under the control of an operating system 714, and executes various computer software applications, components, programs, objects, modules, etc. indicated collectively by reference numeral 716 to perform the techniques described above. In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), flash drives among others. Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A method for facilitating social media interactions, comprising:
allowing a user to record an audio clip as a primary step; and
allowing the user to post said audio clip to a voice portal; and
organizing the audio clips posted by the user on a profile page associated with the user on the voice portal so that each audio clip forms a center for social interaction subsequent social media interactions.

2. The method of claim 1, wherein the subsequent social media interactions are at least by friends of the user.

3. The method of claim 1, wherein the subsequent social media interactions is selected from the group consisting of a comment about an audio clip, a posting of the audio clip to a social media site; and an indication of a liking or a disliking of an audio clip.

4. The method of claim 3, wherein the comment is captured through one of text and voice.

5. The method of claim 1, further comprising allowing the user to perform a secondary step in connection with the audio clip.

6. The method of claim 5, wherein the secondary step comprises tagging the audio clip.

7. The method of claim 5, wherein the secondary step comprises associating an image with audio clip.

8. The method of claim 7, wherein image represents a photograph.

9. The method of claim 7, wherein image represents a greeting.

10. The method of claim 5, wherein the secondary step comprise associating background audio with the audio clip.

11. A non-transitory computer-readable medium having stored thereon a sequence of instructions which when executed by a system causes the system to perform a method, comprising:
allowing a user to record an audio clip as a primary step; and
allowing the user to post said audio clip to a voice portal; and
organizing the audio clips posted by the user on a profile page associated with the user on the voice portal so that each audio clip forms a center for social interaction subsequent social media interactions.

12. The computer-readable medium of claim 11, wherein the subsequent social media interactions are at least by friends of the user.

13. The computer-readable medium of claim 11, wherein the subsequent social media interactions is selected from the group consisting of a comment about an audio clip, a posting of the audio clip to a social media site; and an indication of a liking or a disliking of an audio clip.

14. The computer-readable medium of claim 13, wherein the comment is captured through one of text and voice.

15. The computer-readable medium of claim 11, further comprising allowing the user to perform a secondary step in connection with the audio clip.

16. The computer-readable medium of claim 15, wherein the secondary step comprises tagging the audio clip.

17. A system, comprising:
a processor; and
a memory coupled to the processor, the memory storing instructions that when executed by the processor cause the system to perform a method comprising:
allowing a user to record an audio clip as a primary step; and
allowing the user to post said audio clip to a voice portal; and
organizing the audio clips posted by the user on a profile page associated with the user on the voice portal so that each audio clip forms a center for social interaction subsequent social media interactions.

18. The system of claim 17, wherein the subsequent social media interactions are at least by friends of the user.

19. The system medium of claim 17, wherein the subsequent social media interactions is selected from the group consisting of a comment about an audio clip, a posting of the audio clip to a social media site; and an indication of a liking or a disliking of an audio clip.

20. The system of claim 19, wherein the comment is captured through one of text and voice.
